(19) United States
(12) Patent Application Publication
(10) Pub. No.: US 2007/0252119 A1
(43) Pub. Date: Nov. 1, 2007

(54) Motorcycle front end stand

(75) Inventors: Alfred J. Kobacker II, Columbus, OH (US); Gary P. Zimmerman, Pataskala, OH (US)

Correspondence Address: Thomas S. Baker, Jr., 1371 West 3rd Avenue, Columbus, OH, 43212, US

(73) Assignee: Abranda, LLC

(21) Appl. No.: 11/414,316

(22) Filed: Apr. 28, 2006

(51) Int. Cl. B66F 3/00

(52) U.S. Cl. 254/131

(57) ABSTRACT

A motorcycle front end stand for moving the front end of a motorcycle between front fork raised and lowered positions has a frame with a pair of laterally spaced, upright members, a pivot attachment affixed to each upright member, and a fork support pivotally attached to each of the upright member pivot attachments wherein each of the fork supports have fork engagement elements and the fork engagement elements are positioned below the upright member pivot attachments to provide a stable support for the motorcycle front end while permitting access to the motorcycle front axle when the front fork is mounted in the fork engagement elements and the front end stand is in the front fork elevated position.

### CROSS-REFERENCES

None.

### FIELD OF THE INVENTION

This invention relates to a stand for elevating the front end of a motorcycle.

### BACKGROUND OF THE INVENTION

A motorcycle rear stand is utilized to support a motorcycle when it is being serviced. The rear stand typically engages rear axle projections on opposite sides of the motorcycle wheel or laterally projecting pivot pins affixed to the motorcycle swing arms to move the rear end of the motorcycle between a first position in which both wheels of the motorcycle are on the ground and a second position in which the rear end of the motorcycle including the rear wheel is elevated above the ground. The motorcycle rear stand maintains the motorcycle in a stable upright position for convenient access to the motorcycle as it is being serviced.

On occasion the front end of a motorcycle must be elevated for service purposes. A motorcycle front end stand is used in conjunction with a motorcycle rear stand to accomplish this. Most motorcycle front end stands engage the lower end of a motorcycle front fork for lifting and support purposes to enable a service person to have unimpeded access the motorcycle front axle. Of course, motorcycle front end stands must be capable of accommodating a slight variation in the shape of the fork ends or legs of different motorcycles. The most widely adapted design of motorcycle front end stands uses a pair of fork supports pivotally affixed to the frame of a motorcycle front end stand to engage the legs of a motorcycle fork. Each fork support has a pair of offset pins adapted to engage one leg of a front fork. One pin engages the bottom end of a fork leg and the other pin engages a side wall of a fork leg. The fork supports pivot relative to the frame as the front end stand is raised or lowered to maintain the front fork legs in a fixed position on the fork supports. In these devices, the pivot for the fork support is below the pins that support the front fork legs to allow unimpeded access to the front axle.

Despite the fact that conventional front end stands are used in conjunction with the motorcycle rear end stands to support a motorcycle, the use of conventional front end stands is somewhat difficult. The difficulty arises because the pivots for the fork supports are positioned beneath the pins that support the front fork. If the fork legs are positioned on the respective fork support pins such that the downward force of the legs is directly above the fork support pivots, the motorcycle front end stand is stable. In other words, there is no tendency of the front fork to rotate off of the fork supports. However, if the fork ends or legs are positioned slightly in front of or behind the fork support pivots as the fork legs are lowered onto the fork supports and the downward force applied to the fork supports is offset from the fork support pivots, the downward force of the front fork results in a torque being applied to the fork supports causing them to tend to rotate such that the fork ends may slip off of the fork supports. Thus, exact positioning of the fork legs on the fork support assemblies prior to operating the front end stand to raise the front end of the motorcycle is critical.

It is desirable to provide a motorcycle front end stand having fork supports pivotally affixed to the front end stand frame that are capable of accommodating some misalignment or mispositioning of the fork legs when a front fork is mounted on the fork supports of the front end stand and the front end stand is being raised while providing unimpeded access to the motorcycle front wheel axle. Preferably, any mispositioning of the fork legs on the fork supports would cause the fork supports to move to a position in which the front fork is stabilized on the front end stand.

### SUMMARY OF THE INVENTION

A motorcycle front end stand, moveable between a front fork lowered position and a front fork elevated position, has a frame having a pair of laterally spaced upright members with a pivot attachment affixed to each upright member. A fork support is pivotally attached to each of the upright member pivot attachments and each of the fork supports has a pair of spaced fork engagement elements. The pairs of fork engagement members are positioned below the upright member pivot attachments when a motorcycle front fork is mounted on the pairs of fork engagement members and the front end stand is in the front fork elevated position.

### DESCRIPTION OF THE DRAWINGS

FIG. 1 is a side view of a motorcycle front end stand adjacent the front fork of a motorcycle;

FIG. 2 is a perspective view of the motorcycle front end stand of the instant invention;

FIG. 3 is a side view showing the motorcycle front end stand engaging a motorcycle front fork and in the raised position;

FIG. 4 is a front view showing the motorcycle front end stand engaging a motorcycle front fork and in the raised position;

FIG. 5 is a perspective view showing a leg of a motorcycle front fork engaging the fork engagement elements of a fork support pivotally mounted on the frame upright of a motorcycle front end stand;

FIG. 6 is a side view of the FIG. 5 structure illustrating the force components acting on the fork support when the motorcycle front fork is misaligned with the front end stand fork support pivot axis;

FIG. 7 is a side view of the FIG. 5 structure illustrating the position of the fork support when the motorcycle fork is aligned with the front end stand fork support pivot axis;

FIG. 8 is a perspective view showing a leg of a motorcycle front fork engaging the fork support elements of a prior art motorcycle front end stand;

FIG. 9 is a side view of the FIG. 8 structure illustrating a motorcycle fork properly aligned with the prior art front end stand fork support pivot axis; and

FIG. 10 is a side view of the FIG. 8 structure illustrating the position of a fork support element when a motorcycle fork is misaligned with the prior art front end stand fork support pivot axis.

### DESCRIPTION OF THE PREFERRED EMBODIMENT

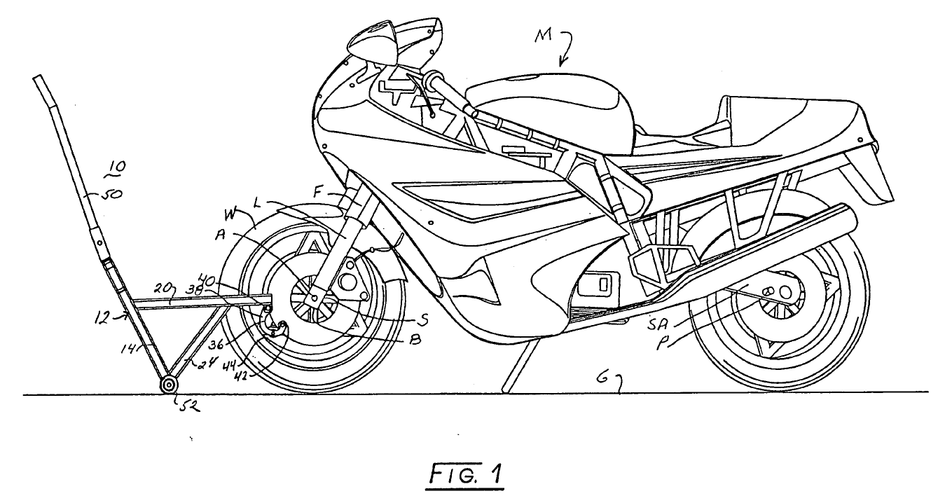

FIG. 1 shows a motorcycle M having a front fork F with a pair of downwardly extending legs L which mount a front wheel W on an axle A in an upright position adjacent a motorcycle front end stand 10 of the instant invention. When the motorcycle M is serviced, a motorcycle rear end stand (not shown) engages pivot pins P mounted on swing arms SA on opposite sides of the rear wheel to maintain the motorcycle M in a stable, upright position. The motorcycle rear end stand also could support the motorcycle by engaging projections of the rear axle on opposite sides of the rear wheel.

On occasion it is necessary to service the motorcycle front wheel axle A mounted at the outer end of the fork legs L. To accomplish this, the motorcycle front end stand 10 is used to engage the lower end of the fork legs L and elevate the front end of the motorcycle, as will be described herein below.

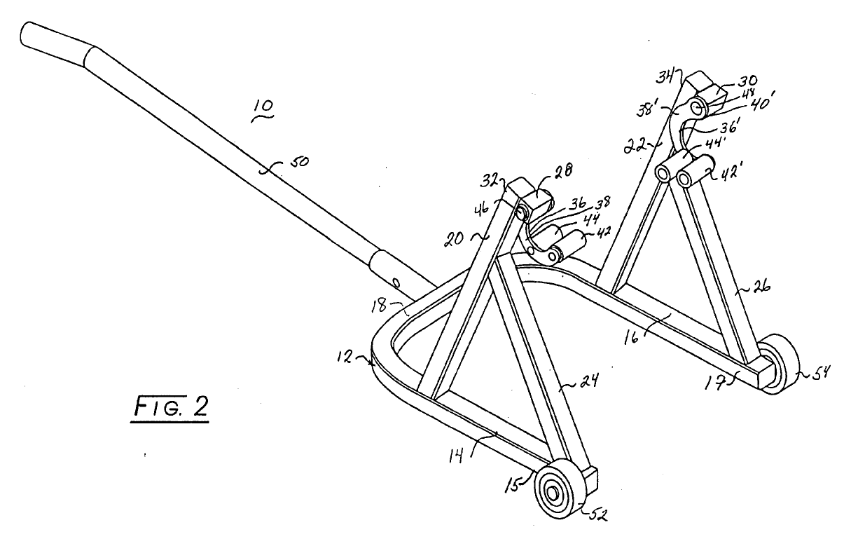

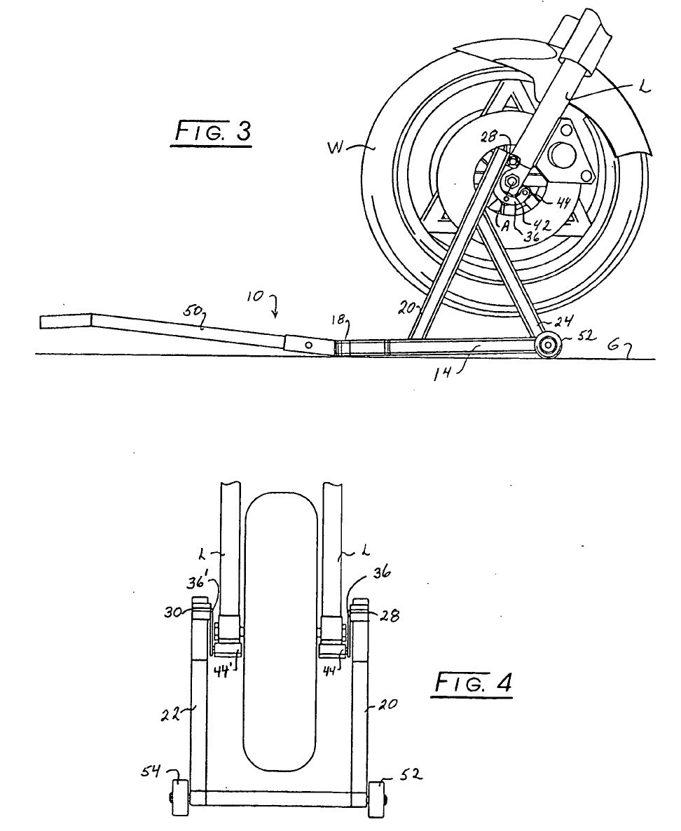

Turning to FIG. 2, it may be seen that motorcycle front end stand 10 has a U-shaped frame 12 with two parallel, longitudinally extending sides 14 and 16 each connected at one end to a lateral side 18. Upright members 20 and 22 are mounted on the longitudinal sides 14 and 16 respectively. Reinforcing arms 24 and 26 project upwardly at an angle from the respective longitudinal sides 14 and 16 and engage the upright members 20 and 22. Pivot assemblies 28 and 30 are mounted at the respective outer ends 32 and 34 of upright members 20 and 22 and are located between frame side 18 and the outer ends 15 and 17 of frame sides 14 and 16 respectively when the front end stand is in the motorcycle front end raised position as depicted in FIGS. 2 and 3. The pivot assemblies 28 and 30 have pins mounted in bores therein.

Fork supports 36 and 36′ are attached to the pivots 28 and 30 respectively. This description will proceed with respect to fork support 36. Identical elements for fork support 36′ will be identified by identical primed numbers.

Fork support 36 has a planar, curved or C-shaped body 38 with a bore 40 at one end thereof. A first laterally projecting fork engagement element 42 is affixed to the other end of body 38 and a second laterally projecting fork engagement element 44 is affixed to body 38 in spaced relationship to fork engagement element 42 and between fork engagement element 42 and pivot bore 40. The fork engagement elements 42 and 44 preferably are generally cylindrical in shape and may be coated with a resilient material such as hard rubber or plastic to prevent scratching the surfaces of a motorcycle fork leg mounted therein.

The fork supports 36 and 36′ are mounted pivotally on pivot assemblies 28 and 30 such that their fork engagement elements 42, 42′ and 44, 44′ face each other. In FIG. 2 of the drawings, it may be seen that pins 46 and 48 pass through pivot bores 40 and 40′ to thereby pivotally mount fork supports 36 and 36′ to the outer ends of the upright members 20 and 22. Alternately, pins 46 and 48 may be rigidly affixed to the fork engagement members 36 and 36′ for engagement with bores in pivot assemblies 28 and 30. It should be noted that fork engagement elements 42, 42′ and 44, 44′ are located below pivot assemblies 28 and 30 when the fork supports 36 and 36′ are mounted thereon.

A longitudinal handle 50 is attached to the lateral side 18 of frame 12 and roller elements which may be casters or wheels 52 and 54 are attached to the outer ends 15 and 17 of the frame sides 16 and 18 to complete the motorcycle front end stand assembly 10. With this construction, pivot assemblies 28 and 30 are positioned between lateral frame side 18 and wheels 52 and 54 when the front stand 10 is in the motorcycle raised position, as shown in FIG. 3.

Operation of the motorcycle front end stand 10 to raise the front end of a motorcycle may be seen by referring to FIGS. 1 through 4. Initially, handle 50 is pivoted clockwise to thereby lower pivot assemblies 28 and 30 and their respective fork supports 36 and 36′ such that their respective fork engagement elements 42, 44 and 42′, 44′ are below the bottoms B of the motorcycle fork legs L, as illustrated in FIG. 1. The stand 10 is moved toward the motorcycle fork F on wheels 52 and 54 and handle 50 is pivoted counterclockwise until the fork engagement elements 44, 44′ are adjacent the bottom B of fork leg L and the fork engagement elements 42, 42′ are adjacent the rear side S of motorcycle fork leg L. Continued counterclockwise rotation of handle 50 causes fork engagement elements 44, 44′ to engage the bottoms B of fork legs L and fork engagement elements 42, 42′ to engage the back or rear sides S of fork legs L. Further rotational movement of handle 50 causes frame 12 and fork supports 36, 36′ to rotate about pivot assemblies 28 and 30. As this occurs, the wheel end of frame 12 moves towards the pivot assemblies 28 and 30 and raises the pivot assemblies 28 and 30 to thereby lift the front end of motorcycle M. Continued rotational movement of frame 12 causes wheels 52 and 54 to move to the right of pivot assemblies 28 and 30, that is pass over center, such that pivot assemblies 28 and 30 are positioned between lateral frame side 18 and the outer ends 15 and 17 of frame sides 14 and 16 and the front end of motorcycle M is raised, as shown in FIG. 3. After wheels 52 and 54 have passed over center and handle 50 engages the ground, the front end stand 10 provides stable support for the motorcycle front end. The curved shape of fork supports 36, 36′ permits unimpeded access to axle A.

To move the motorcycle front end stand 10 from the raised position, shown in FIGS. 2 through 4, to the lowered position, shown in FIG. 1, handle 50 and frame 12 are rotated clockwise about pivot assemblies 28 and 30 to cause the wheeled outer ends 15 and 17 of frame sides 14 and 16 to move leftwards towards pivot assemblies 28 and 30. As the outer ends 15 and 17 of sides 14 and 16 pass beneath pivot assemblies 28 and 30 and continue to move leftward, the pivot assemblies 28 and 30 at the outer ends 32 and 34 of upright members 20 and 22 and the fork supports 36 and 36′ supporting fork legs L, move downwardly to lower the motorcycle axle A and front wheel W to the ground G. When wheel W touches the ground G, the motorcycle frame 12 is in the lowered position, as illustrated in FIG. 1.

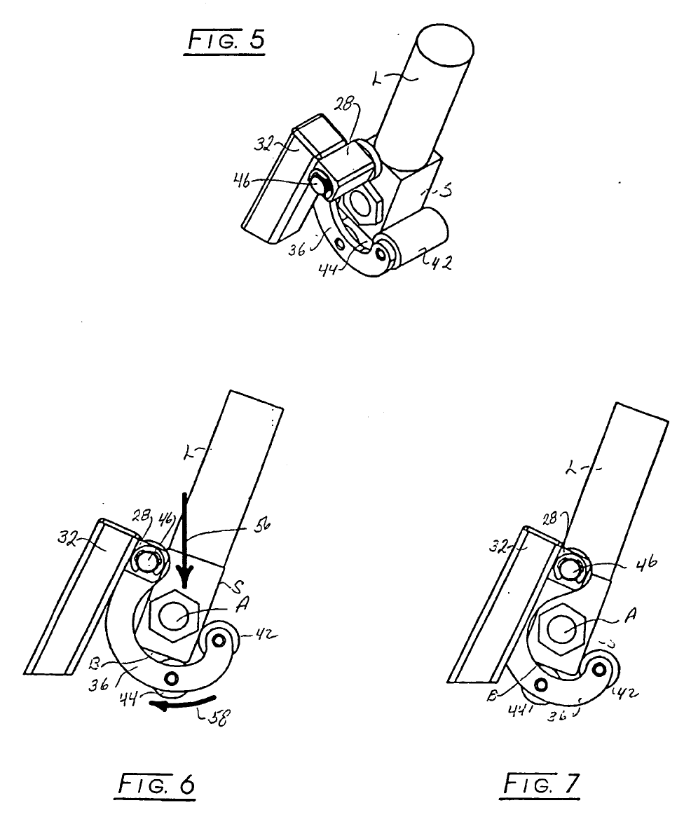

FIGS. 5 through 7 depict the movement of fork support 36 as the motorcycle front end is raised. While only one side of the motorcycle front end stand 10 is depicted in FIGS. 5 through 7, it should be understood that the opposite side having identical elements operates in the same manner. Referring to FIG. 6, it may be seen that when the fork engagement elements 42 and 44 initially engage the side S and the bottom B of the fork leg L, the downward force component applied to fork support 36 by leg L and depicted by arrow 56 is offset to the right of pivot pin 46 of pivot 28. As the motorcycle front end stand 10 continues to rotate counterclockwise about pivot assembly 28 and lift the pivot assembly, the outer frame side ends 15 and 17 of fork leg L move toward the pivot assemblies 28 and 30 such that the front wheel of the motorcycle is raised from the ground G. At the same time, the downward force component 56 from the weight of leg L applies a clockwise torque 58 on the fork support 36. This causes the fork support 36 to rotate about pivot 28 until the downward force component 56 is centered through the pivot 28, as depicted in FIG. 7. Similarly, if the fork support elements 42 and 44 engaged the rear side S and bottom B of fork leg L in such a manner that the downward force component 56 of the weight of leg L was to the left of pivot 28, fork support 36 would pivot counterclockwise until the downward force component 56 was once again centered with respect to the pivot 28, as depicted in FIG. 7. This self-aligning feature of fork supports 36 and 36′ occurs because the fork engagement elements 42, 42′ and 44, 44′ of the fork supports 36 and 36′ are positioned below the fork support pivot assemblies 28 and 30 when the front end stand 10 is in or moving towards the raised position. From this it may be seen that the subject front end stand 10 enables the fork supports 36 and 36′ to receive and to accommodate misalignment of fork legs L with respect to the pivot assemblies 28 and 30 as the front end of the motorcycle is raised while providing full access to the front axle A of the motorcycle.

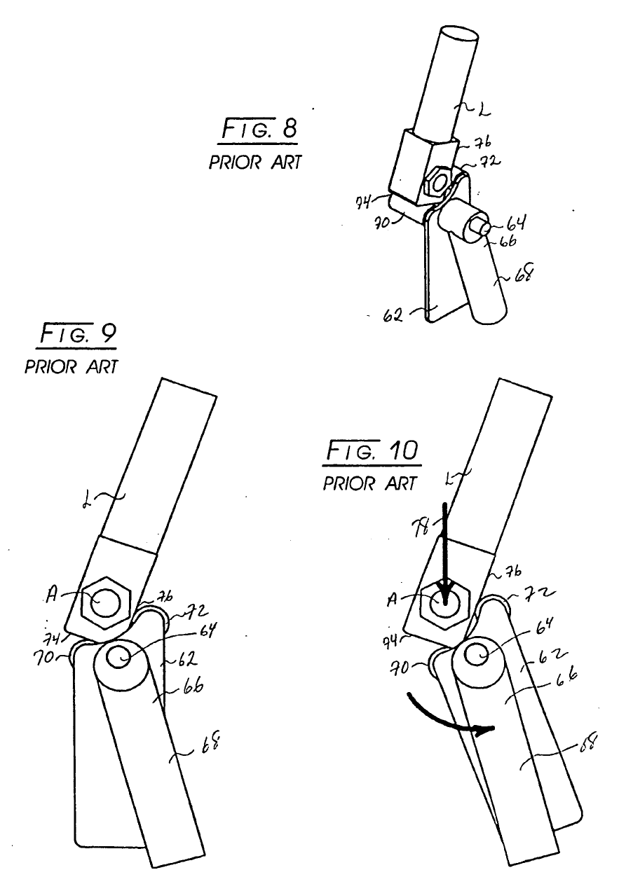

In prior art motorcycle front end stands the fork support fork engagement elements are located above the fork support pivots. This arrangement provides unimpeded access to the motorcycle front wheel axle. Referring to FIGS. 8 through 10, it may be seen that a fork support 62 is attached to a pivot 64 mounted at the outer end 66 of an upright arm 68 affixed to a frame not shown in the conventional manner. Fork engagement elements 70 and 72 are mounted on fork supports 62 above fork pivots 64. Fork engagement element 70 engages a fork leg bottom surface 74 and fork engagement element 72 engages a fork leg rear side surface 76. When the downward force component from the weight of fork leg L is centered with respect to fork support pivot 64, as depicted in FIG. 9, the structure is stable and the motorcycle front fork is safely supported on the fork support 62 at the outer end of upright 68 as the front end stand lifts the front end of the motorcycle. Unfortunately, in the course of maneuvering a motorcycle front end stand to engage the bottom and rear side surfaces 74 and 76 of a fork leg L, it sometimes happens that the downward force component 78 of the weight of the fork leg L is offset to one side or the other of fork support pivot 64, as illustrated in FIG. 10. In FIG. 10, the downward force component 78 is shown to the left of fork support pivot 64. This causes a clockwise torque to be applied to fork support 62 as the motorcycle front end stand is lifted. When this occurs, fork support 62 rotates about its pivot 64 and the motorcycle leg L tends to roll off of or to become disengaged from fork engagement elements 70 and 72. Because the fork support pivot 64 is below the fork engagement elements 70 and 72, the structure cannot self-center with respect to fork support pivot 64 to accommodate an offset motorcycle fork leg L. In contrast thereto, in applicant's structure with the fork support pivots 28 and 30 positioned above the fork engagement elements 74 and 76 as the front end stand rotates to lift the front end of a motorcycle, any downward component of force 56 offset to one side or the other of the pivots 28 and 30 causes the fork supports 36 and 36′ of fork legs L to rotate towards the pivots 28 and 30, and thereby, self-center.

From the above, it may be seen that the motorcycle front end stand 10 of the instant invention having fork supports 36 and 36′ with fork engagement elements 42 and 44 located beneath the fork support pivot assemblies 28 and 30 while providing unimpeded access to the front wheel axle. This structure enables the motorcycle front end stand 10 to safely raise and secure the front end of a motorcycle when the downward force component 56 of the front fork legs L is offset with respect to the pivot axis of the fork supports 36 and 36′ when the front end stand initially engages and subsequently raises the fork of a motorcycle.

Various changes may be made to the size, shape, and relative proportions of the different invention elements disclosed and described herein without departing from the scope, meaning, or intent of the claims which follow.

I claim as my invention:

1. A motorcycle front end stand movable between a front fork lowered position and a front fork elevated position which comprises:
a frame having a pair of laterally spaced upright members;
a pivot attachment affixed to each upright member;
a fork support pivotally attached to each of said upright member pivot attachments;
each of said fork supports having fork engagement elements; and
wherein said fork engagement members are positioned below said upright member pivot attachments when a motorcycle front fork is mounted in said fork engagement members and said front end stand is in said front fork elevated position.

2. The motorcycle front end stand of claim 1, said frame further comprising a pair of spaced parallel sides having inner and outer ends and connected at their inner ends to a lateral side lift member and wherein said upright members are mounted one on each of said parallel sides.

3. The motorcycle front stand of claim 2 further comprising roller elements attached at the outer end of said parallel sides.

4. The motorcycle front end stand of claim 1 wherein said fork engagement elements have a spaced pair of lateral members.

5. The motorcycle front end stand of claim 1 wherein said fork supports are curved, said fork engagement elements are mounted at one end of said fork supports and said pivot attachment is at the other end of said fork support.

6. A motorcycle front end stand movable between a front fork lowered position and a front fork elevated position which comprises:
a frame having a pair of laterally spaced upright members;
a pivot attachment affixed to each upright member;
a pair of fork supports each having fork engagement elements at a lower end of the fork support and a pivot element at an upper end of the fork support;
each of said fork support pivot elements attached to one of said upright member pivot attachments; and
wherein said fork engagement elements are positioned below said upright member pivot attachments such that the weight of a motorcycle front fork causes the fork supports to pivot to a position in which the downward force component of the fork weight is aligned with the fork support pivot elements when a motorcycle front fork is mounted in said fork engagement members and said front end stand is in said front fork elevated position.

7. The motorcycle front end stand of claim 6, said frame further comprising a pair of spaced parallel sides having inner and outer ends and connected at their inner ends to a lateral side lift member and wherein said upright members are mounted one on each of said parallel sides.

8. The motorcycle front end stand of claim 7 further comprising roller elements attached at the outer end of said parallel sides.

9. The motorcycle front end stand of claim 6 wherein said fork engagement elements have a spaced pair of lateral members.

10. A motorcycle front end stand movable between a front fork lowered position and a front fork elevated position which comprises:
a frame having a pair of spaced longitudinally extending side members connected by a lateral side member at one end;
an upright member having inner and outer ends and mounted with its inner end on each of said longitudinally extending side members;
a pivot assembly mounted at the outer end of each of said upright members;
a fork support having fork engagement elements pivotally attached to the pivot assemblies;
a roller element mounted at the other end of the frame;
wherein said fork engagement elements are positioned below said pivot assemblies when the motorcycle front fork is supported in said fork engagement elements and the motorcycle front end stand frame is rotated such that the pivot assemblies are between said one and said other ends of said frame.

11. The motorcycle front end stand of claim 10 wherein said fork engagement elements have a spaced pair of lateral members.

12. The motorcycle front end stand of claim 10 wherein said fork supports are curved, said fork engagement elements are mounted at one end of said fork supports and said pivot assembly is at the other end of said fork support.
